(19) United States
(12) Patent Application Publication
(10) Pub. No.: US 2005/0137930 A1
(43) Pub. Date: Jun. 23, 2005

(54) Electronic leave-application method and the system thereof

(75) Inventor: Yoco Hung, Shindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/010,965

(22) Filed: Dec. 13, 2004

(30) Foreign Application Priority Data
Dec. 18, 2003 (TW) 92136041

(51) Int. Cl. G06F 17/60

(52) U.S. Cl. 705/9

(57) ABSTRACT

A method for electronically processing leave-application and the system thereof are provided. First, an electronic-application form is produced by an applicant, who inputs leave information including leave period, leave purpose, leave type, and the applicant's deputy. Then, the management level to approve the leave-application is determined according to the leave information provided, and the electronic leave-application form is sent automatically to a corresponding supervisor for approval. If approved, the approval notification of the leave application is automatically sent to the applicant, the applicant's deputy and relevant personnel, otherwise, the disapproval notification is sent to the applicant.

This application claims the benefit of Taiwan application Serial No. 92136041, filed Dec. 18, 2003, the subject matter of which is incorporated herein by reference.

### BACKGROUND OF THE INVENTION

1. Field of the Invention

The invention relates to a method for electronically processing leave-application and the corresponding system thereof.

2. Description of the Related Art

Efficiency is a key factor for a business or an organization to improve its competitive capacity.

Conventionally, if an employee would like to take leave, the employee must fill in a leave-application form before presenting a leave application. However, when filling in the application form, the employee might not have the knowledge of the available length of unused leaves.

Therefore, the employee would not know beforehand if the intended length is over the available length of unused leave or how to make an arrangement between holiday leave and ordinary leaves, and cannot schedule leave plan for next year. He or she must go to the consult the human resources department for more information. However, the in-charge person of the human resources department might not be at the office all the time, and the employee might have to make a guess regarding the available length of unused leaves when filling in the leave period he or she would like to leave hereinto. When the intended length is over the limit, he or she needs to fill in a new application form and apply again.

In addition, suppose that the employee would like to consult the human resources department and fill in all items in the leave-application form over there, and then present the leave application to a second management level supervisor for approval. However, if the employee cannot locate the second management level supervisor, the procedure of leave application will be halted; meanwhile, the employee might be distracted by the leave application and cannot concentrate on the work. Moreover, a long leave, an annual leave to travel overseas for instance, normally needs to be approved by a higher level supervisor, so the processing of the leave application will be further delayed, increasing costs to both the employee and the business or the organization. In a large business, a large number of employees go through the leave-application routine everyday, and the waste of time and effort will cost the business or the organization considerably. The need for a solution to resolve the above identified problem thus emerges.

### SUMMARY OF THE INVENTION

The invention provides a method for electronically processing leave application. Firstly, an electronic leave-application form is generated according to the leave information inputted by an applicant, including at least leave period, leave purpose, leave type and deputy of the applicant. Next, automatically determine an authorized management level and send the electronic leave-application form to the supervisor of the authorized management level and receive the result, wherein the method automatically determines an authorized management level according to the information provided in the leave application and then sends the electronic leave-application form to the supervisor of respective authorized management level for approval. If approved, proceed to next step; otherwise, inform the applicant of the result of disapproval. Inform the applicant, the deputy and relevant personnel of the approval of leave application by sending a message automatically.

In the step of generating an electronic leave-application form step, the invention will generate the electronic leave-application form for the leave application of any leave type only if the intended leave length is within an allowed limit. Besides, the step of determining the authorized management level step can be shifted forward to be next to the step of generating a leave-application form; meanwhile, the other steps will be performed as scheduled. Moreover, whether to further send the application to a higher management level for approval in the step of determining an authorized management level can be determined according to the intended leave length.

The invention also provides an electronic leave-application system. The system includes a personal leave-application database for recording the available length of respective unused leave for at least one employee; a departmental leave-application database for recording at least one departmental leave-application term for at least one department; a personnel authorization database for recording at least one relevant personnel to be noticed or countersigned for each leave type; a leave-application processing interface for the user to inquire the personal leave-application database or the departmental leave-application database when filling in the electronic leave-application form, and a leave-application status instant notice routine for giving instant notice to the relevant personnel during each stage of the leave-application procedure and for coordinating the update of the personal leave-application database, the departmental leave-application database, the personnel authorization database and the leave-application processing interface.

Other objects, features, and advantages of the invention will become apparent from the following detailed description of the preferred but non-limiting embodiments. The following description is made with reference to the acbusinessing drawings.

### BRIEF DESCRIPTION OF THE DRAWINGS

FIG. 1 is a flowchart of leave application according to a preferred embodiment of the invention;

FIG. 2.is a flowchart of leave application according to another preferred embodiment of the invention;

FIG. 3 a flowchart of leave withdrawal according to a preferred embodiment of the invention;

FIG. 4 a flowchart of leave withdrawal according to another preferred embodiment of the invention; and

FIG. 5 is a block diagram of an electronic leave-application system.

### DETAILED DESCRIPTION OF THE INVENTION

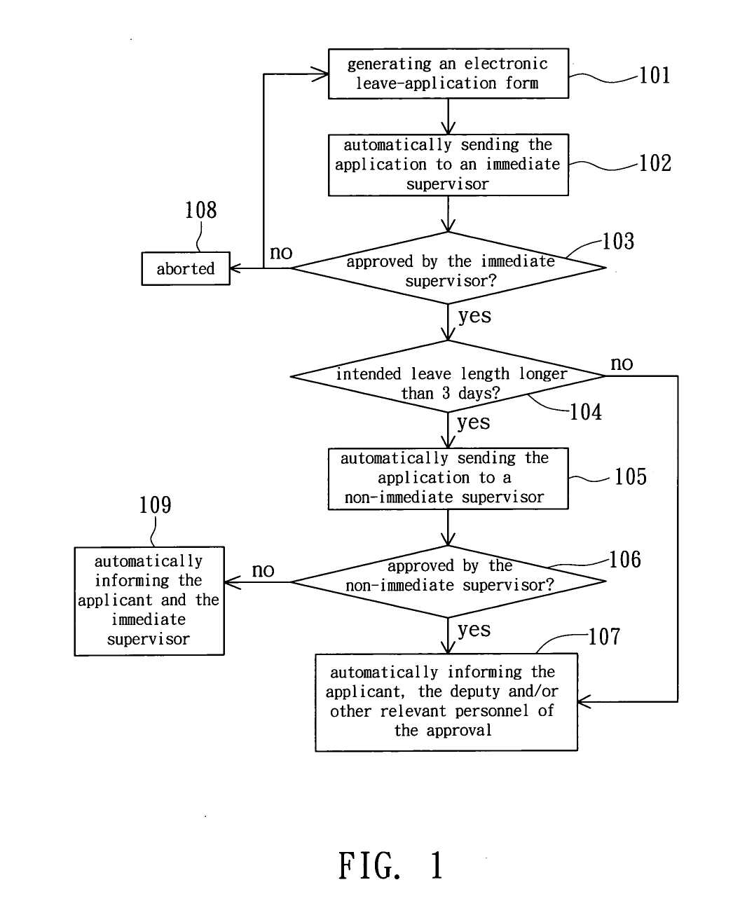

Referring to FIG. 1, a flowchart of leave application according to a preferred embodiment of the invention is shown. The method begins at step 101 of generating an electronic leave-application form, wherein the electronic leave-application form is generated after the electronic leave-application system has received leave information inputted in the leave-application form, e.g., leave period, leave purpose, leave type, and deputy of the applicant. Moreover, through the electronic leave-application system, the applicant can consult the electronic leave-application system regarding his or her personal leave-application data, so as to promptly find out the available length of unused leaves before filling in the electronic leave-application form. In step 102, the electronic leave-application system automatically sends the application to the applicant's immediate supervisor for approval. In step 103, if the application is approved by the immediate supervisor, proceed to step 104; otherwise, the user can either abort the leave application as shown in step 108 or return to step 101 to correct the electronic leave-application form and re-generate a new electronic leave-application form.

Having been approved by the immediate supervisor, the electronic leave-application system will proceed to step 104 of determining whether the approval of leave application is beyond the individual authorization of the immediate supervisor. For example, whether the intended length in the leave application is over the authorized limit of the immediate supervisor, say, 3 days: if so, proceed to step 105; otherwise, proceed to step 107 of automatically informing the applicant, the deputy and/or other relevant personnel of the approval via instant notice method such as mailing, e-mailing, or sending text message so that the relevant personnel can make arrangement in advance. The restrictive condition in step 104 does not necessary to be limited to the leave length in the leave application: the leave period can be set as a restrictive condition as well.

If the approval of leave application is beyond the individual authorization of the immediate supervisor, for example, the intended leave length in the application is over the authorized limit of the immediate supervisor, say, 3 days, then proceed to step 105 of automatically sending the application to other supervisors for approval. In this step, the electronic leave-application system automatically sends the electronic leave-application form to other supervisor for approval, a non-immediate supervisor or a higher level supervisor for instance, and receives the result. In step 106, if approved by a higher level supervisor, then proceed to step 107; otherwise, inform the applicant and the immediate supervisor of the disapproval via mails as shown in step 109.

Meanwhile, if the application is approved by the higher level supervisor, then proceed to step 107 in which the electronic leave-application system automatically informs the applicant, the deputy and other relevant personnel of the approval via mail, e-mail, text message, so that the relevant personnel can make arrangement in advance. Hence, the electronic leave-application system completes the leave-application procedures for the applicant.

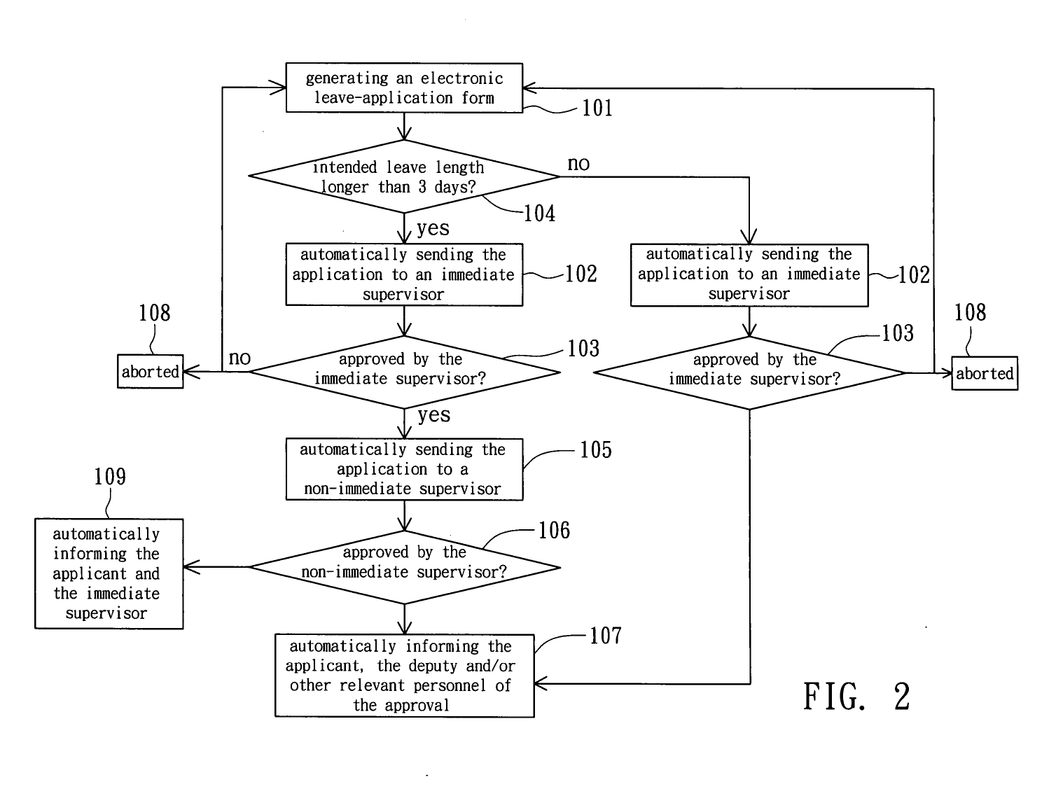

Referring to FIG. 2, a flowchart of leave application according to another preferred embodiment of the invention is shown. The present preferred embodiment is not implemented in the order of step 101, step 102, step 103, step 104 to step 107 sequentially. With step 104 being shifted to be after step 101, the present embodiment is now in a new order of step 101, step 104, step 102, step 103, step 105, step 106, and step 107. That is to say, after having generated an electronic leave-application form in step 101, the method proceeds to step 104 of determining whether the approval of the leave application is within the individual authorization of the immediate supervisor: if so, sequentially perform step 102, step 103, step 105, step 106 and step 107; if the approval is beyond the individual authorization of the immediate supervisor, sequentially proceeds step 102, step 103, and step 107 or 108.

Whether to choose the preferred embodiment illustrated in FIG. 1 or that illustrated in FIG. 2 depends on the consideration of the business or the organization. Despite previous preferred embodiment only requires the approval from an immediate supervisor and a higher level supervisor, the spirit of the invention can be extended to cover the case when approval from several supervisors are required. Although the preferred embodiment takes the supervisor as the authorized person to approve the application, the spirit of the invention can be extended to any other authorized personnel to give approval regardless of their positions and titles. Furthermore, when the application needs to be approved by several supervisors, a combination of the procedures in FIG. 1 and that in FIG. 2 can be used in getting approval from different supervisors.

Since an applicant might have to withdraw the leave application, which has been lodged or even approved, due to some unexpected factors and that an applicant has to write off the application after the leave ahs been taken, the invention can further comprises an electronic leave-withdrawal routine. Here, the electronic leave-withdrawal routine is similar to the electronic leave-application routine disclosed above except that the electronic leave-application system is used to process the electronic leave-withdrawal form instead of the electronic leave-application form.

According to the approved electronic leave-application form, an electronic leave-withdrawal form is generated via the leave-application processing interface of the electronic leave-application system.

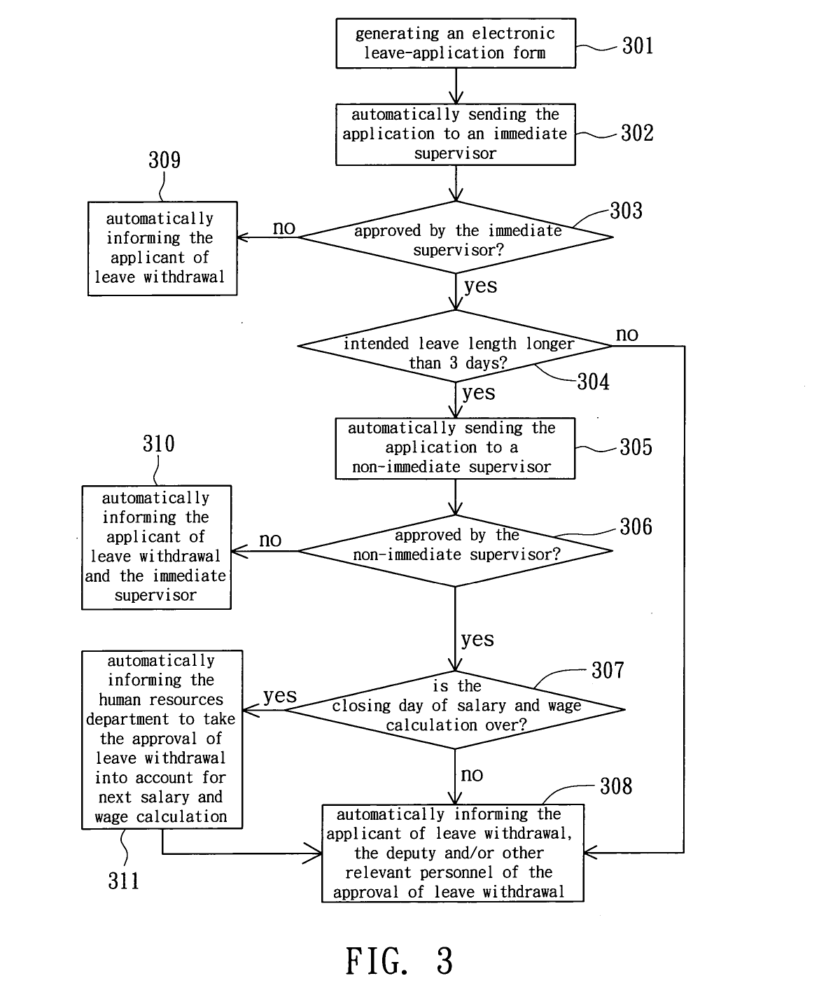

Referring to FIG. 3, a flowchart of leave withdrawal according to a preferred embodiment of the invention is shown. Firstly, the method begins at step 301 of generating an electronic leave-application form. Then, the electronic leave-application system receives an electronic leave-withdrawal form which has been approved by a first level supervisor from an applicant, the one who applies for a leave withdrawal. Next, in step 302, the electronic leave-application system automatically sends the application to an immediate supervisor. After the electronic leave-withdrawal form has been generated, proceed to step 302 of automatically sending the electronic leave-withdrawal form to the applicant's immediate supervisor for approval by the electronic leave-application system. Proceed to step 303: if the application is approved by the immediate supervisor, then proceed to step 304; otherwise, automatically informs the applicant of the leave-application of the disapproval. The applicant can either abort the application of leave withdrawal or return to step 301 to correct the electronic leave-withdrawal form and generate a new electronic leave-withdrawal form.

Having been approved by the immediate supervisor, the electronic leave-application system proceeds to step 304 of determining whether the approval of leave-withdrawal is beyond the individual authorization of immediate supervisor. For example, whether the intended leave length in the leave application is over the authorized limit of the immediate supervisor, say, 3 days for instance. If so, proceed to step 305; otherwise, proceed to step 308 of informing the applicant, the deputy and/or other relevant personnel of the approval via instant notice method such as mailing, e-mailing, or sending text message so that the relevant personnel can make arrangement in advance. Of course, the decision criterion in step 304 does not necessary to be limited to the leave length: the leave period can be set as a restrictive condition as well. For example, the electronic leave-application system can restrict the employees not to take annual leave during a high season. The electronic leave-application system automatically accesses restrictive conditions of leave application from the database, applies the restrictive conditions to the processing of the electronic leave-withdrawal form, and gives notice to the relevant personnel.

If the supervisor has approved the application in step 306, then the electronic leave-application system has to determine whether the closing day of salary or wage calculation is over or not in step 307: if so, proceed to step 311; otherwise, proceed to step 308 of informing the applicant, the deputy and/or other relevant personnel of the approval of leave withdrawal via instant notice method such as mailing, e-mailing, or sending text message by the electronic leave-application system so that the relevant personnel can restore the arrangements which had been made in response to previous approval of leave application. If the closing day of salary or wage calculation is already over as shown in step 311, then the electronic leave-application system automatically may send mails to inform the human resources department of the approval of leave withdrawal and proceed to step 308 of informing the applicant, the deputy and/or other relevant personnel of the approval of leave withdrawal via instant notice method such as mailing, e-mailing, or sending text message. The withdrawal of leave application will be taken into account in next salary or wage calculation. The method may end here. The reason for proceeding to step 307 is that the applicant of leave application will be deducted a leave deduction from his or her salary or wage if the leave application had already been lodged before the closing day of salary or wage calculation but was withdrawn after the closing day of salary or wage calculation. Such a leave deduction must be reported to the human resources department to be compensated in the next salary or wage payment.

Despite the approval of leave withdrawal only requires the approval from an immediate supervisor and a higher level supervisor in the present preferred embodiment, the spirit of the invention can be extended to take various situations into consideration and cover various situations, for example, approval from the supervisor of only one management level or from several management level supervisors are required. Besides, the preferred embodiment does not restrict the sequence of informing the human resources department first and the deputy afterwards or the other way round. These details can be adjusted according to the convention and practice in a business or an organization.

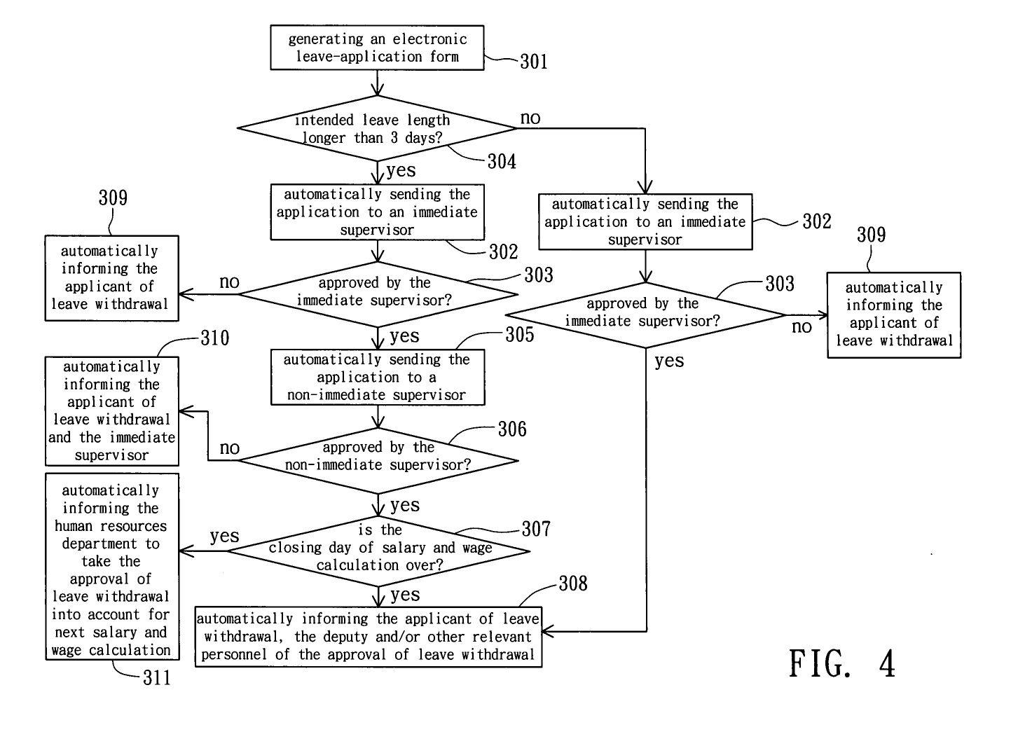

Referring to FIG. 4, a flowchart of leave withdrawal according to another preferred embodiment of the invention is shown. With shifts step 304 being shifted to be after step 301, the present preferred embodiment is now in the order of step 301, step 304, step 302, step 303, step 305, step 306, step 307 and step 308. That is to say, after having generated an the electronic leave-withdrawal form in step 301, the method proceeds to step 304 of determining whether the approval of the leave withdrawal is within the individual authorization of the immediate supervisor: if so, sequentially perform step 302, step 303, step 305, step 306, step 307, and step 308; otherwise, sequentially proceeds to step 302, step 303, and step 308 or 309. Whether to choose the preferred embodiment illustrated in FIG. 3 or that illustrated in FIG. 4 has to take real practices into consideration. In the situation when only one management level is involved, there is no need to determine whether the approval is beyond the individual authorization of the supervisor. When supervisors of more than two management levels are involved, the system simply has to add corresponding steps of determining whether a supervisor's approval is beyond his or her individual authorization or not.

The leave-application procedures illustrated in FIG. 1 of the invention can be combined with the leave-withdrawal procedure in FIG. 3 or that in FIG. 4 respectively. Similarly, the leave-application procedures illustrated in FIG. 2 of the invention can be combined with the leave-withdrawal procedure in FIG. 3 or that in FIG. 4 respectively. The choice of combination depends on the real situations and needs.

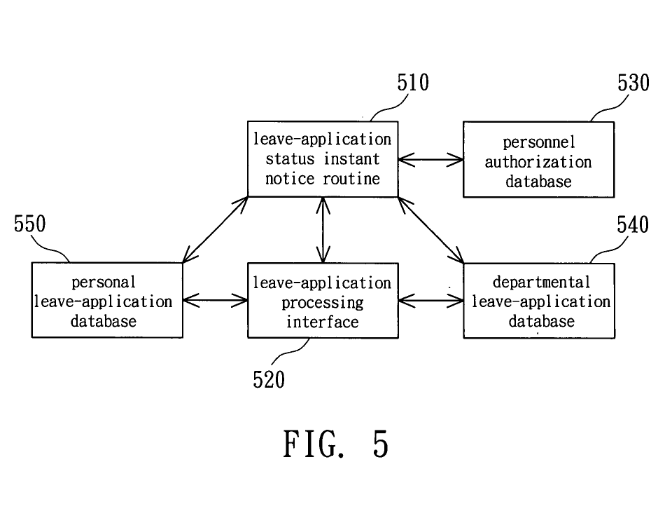

The invention also provides an electronic leave-application system, which is capable of implementing the method disclosed in the above preferred embodiment as shown in FIG. 5, comprising at least a leave-application status instant notice routine 510, a leave-application processing interface 520, a personnel authorization database 530, a departmental leave-application database 540, and a personal leave-application database 550. The personal leave-application database 550 is for recording the available length of respective unused leave of an employee. The departmental leave-application database 540 is for recording departmental leave-application terms. Such terms are not limited to leave length: leave period can also be used as a restrictive term. For example, if a certain week happens to be very busy, that week can be excluded from the available leave period. The personnel authorization database 530 is for recording relevant personnel to be informed of or countersigned for each leave type. The leave-application processing interface 520 is for the applicant or supervisor to inquire the personal leave-application database 550 or the departmental leave-application database 540 for filling in the electronic leave-application form or the leave-withdrawal form etc. The leave-application status instant notice routine 510 is for giving instant notice to the relevant personnel during each stage of the leave-application procedure via mobile phone, pager, text message or website page, etc., and for coordinating the update of the personal leave-application database. The leave-application status instant notice routine 510 also co-ordinates the personal leave-application database 550, the departmental leave-application database 540, the personnel authorization database 530, and the leave-application processing interface 520. For example, the leave-application status instant notice routine 510 will update the personal leave-application database 550 and/or the departmental leave-application database 540 according to the processing and results of the leave application. It must be emphasized here that the invention has no restriction with regard to what specific programming languages or commercial database software are to be used. Any computer software capable of providing the above disclosed functions will do and can be used in the invention.

It can be seen from the above preferred embodiments that the electronic leave-application procedure according to the invention not only saves costs but also has the following advantages of:
1. When filling the leave-application form, the applicant can have the knowledge of the available length of unused leaves so that he or she can make best arrangement in advance without having to go consult the human resources department in person, thus avoiding the trouble of having to re-fill the application form and go through the countersigning process;
2. The supervisor can have correct information regarding current status of leave application whereby an appropriate human resource arrangement can be made;
3. Informing the deputy and relevant personnel helps to prevent the chaos or suspension of a matter that may arise in the absence of prior arrangements;
4. Apart from the signature of the applicant and that of relevant personnel who need to countersign, all procedures can be done through the computer.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for electronically processing applicant's leave application, comprising:
generating an electronic leave-application form by an electronic leave-application system according to the information inputted by the applicant comprising at least leave period, leave purpose, leave type and deputy of the applicant;
automatically determining the authorized management level, sending the electronic leave-application form to supervisors within the authorized management level, and receives the result of the supervisor's decision by the electronic leave-application system, wherein the authorized management level for approving the leave application is determined according to the information provided in leave application, then the electronic leave-application form is automatically sent to respective supervisor at each level within the authorized management level: if approved, proceed to the next step, otherwise, inform the applicant of the disapproval; and
automatically informing the applicant, the deputy and relevant personnel of the approval of leave application via automatic message sending by the electronic leave-application system.

2. The method according to claim 1, wherein the step of determining the authorized management level is determined according to the intended length of leave in the electronic leave-application form.

3. The method according to claim 1, wherein the step of automatically determining the authorized management level, sending the application form for approval and receiving the results is implemented in the sequence of determining all relevant supervisors required to approve the application, sending the application to the relevant supervisors from bottom up until all relevant supervisors have given their decisions.

4. The method according to claim 1, wherein the step of automatically determining the authorized management level, sending the application form for approval and receiving the results starts with the lowest ranked supervisor: if the application is disapproved, the step of automatically determining, sending and receiving will be terminated accordingly, otherwise, determine whether the application has to be sent to a higher level supervisor according to the leave information provided: if so, send the leave information to the higher level supervisor and repeat the above procedure, otherwise, automatically terminate the step of determining, sending and receiving.

5. The method according to claim 1, wherein if the approval of a leave withdrawal is over the individual authorization of a certain level supervisor, then proceed to the step of sending the electronic leave-withdrawal form to a higher level supervisor for approval.

6. The method according to claim 1, further comprising:
generating an electronic leave-withdrawal form by an electronic leave-application system, wherein the applicant presents an application to withdraw a leave application which has been approved by a first level supervisor;
automatically determining the authorized management level, sending the electronic leave-withdrawal form to supervisors within the authorized management level, and receives the result of the supervisor's decision by the electronic leave-application system, wherein the authorized management level for approving the application of leave withdrawal is determined according to the leave information provided in leave application, then the electronic leave-withdrawal form is automatically sent to respective supervisor at each level within the authorized management level: if approved, proceed to the next step, otherwise, inform the applicant of the disapproval; and
automatically determining whether the closing day of salary or wage calculation is over or not: if not, automatically inform the applicant, the deputy and relevant personnel of the approval of leave withdrawal; otherwise, inform the human resources department of the approval of leave withdrawal, which will be taken into account in next salary or wage calculation, and inform the applicant, the deputy and relevant personnel of the approval of leave withdrawal.

7. The method according to claim 6, wherein the step of determining the authorized management level is determined according to the intended length of leave in the electronic leave-application form.

8. The method according to claim 6, wherein the step of automatically determining the authorized management level, sending the application form for approval and receiving the results is implemented in the sequence of determining all relevant supervisors required to approve the application, sending the application to the relevant supervisors from bottom up until all relevant supervisors have given their decisions.

9. The method according to claim 6, wherein the step of automatically determining the authorized management level, sending the application form for approval and receiving the results starts with the lowest ranked supervisor: if the application is disapproved, the step of automatically determining, sending and receiving will be terminated accordingly, otherwise, determine whether the application has to be sent to a higher level supervisor according to the leave information provided: if so, send the leave information to the higher level supervisor and repeat the above procedure, otherwise, automatically terminate the step of determining, sending and receiving.

10. The method according to claim 6, wherein if the approval of a leave withdrawal is over the individual authorization of a certain level supervisor, then proceed to the step of sending the electronic leave-withdrawal form to a higher level supervisor for approval.

11. The method according to claim 1, wherein in the step of generating an electronic leave-application form step, the electronic leave-application system will check first whether the intended leave length of respective leave type in the electronic leave-application form is within the upper limit allowed: if so, an electronic leave-application form will be generated, otherwise, the electronic leave-application form will not be generated.

12. An electronic leave-application system, comprising:
a personal leave-application database for recording the available length of respective unused leave for at least one employee;
a departmental leave-application database for recording at least one departmental leave-application term for at least one department;
a personnel authorization database for recording at least one relevant personnel to be noticed or countersigned for each leave type;
a leave-application processing interface for the user to inquire the personal leave-application database or the departmental leave-application database when filling in the electronic leave-application form; and
a leave-application status instant notice routine for giving instant notice to the relevant personnel during each stage of the leave-application procedure and for coordinating the update of the personal leave-application database, the departmental leave-application database, the personnel authorization database and the leave-application processing interface.

13. The system according to claim 12, wherein the leave-application processing interface can be used for filling in an electronic leave-withdrawal form.

14. The system according to claim 12, wherein the terms of leave application restrict the leave length and leave time.

15. The system according to claim 14, wherein the leave-application processing interface receives leave information such as leave period, leave purpose, leave type and deputy of the applicant inputted by the applicant.

16. The system according to claim 12, wherein leave-application status instant notice routine informs relevant personnel via e-mail, mobile phone, pager or website page.

17. The system according to claim 12, wherein the leave-application status instant notice routine records the processing of leave application in the personal leave-application database for future inquiries.
